(19) United States
(12) Patent Application Publication
(10) Pub. No.: US 2019/0168696 A1
(43) Pub. Date: Jun. 6, 2019

(54) DYNAMIC WIRELESS CONFIGURATION OF A VEHICLE VIA A NETWORK SLICE

(71) Applicants: AT&T INTELLECTUAL PROPERTY I, L.P., Atlanta, GA (US); AT&T Mobility II LLC, Atlanta, GA (US)

(72) Inventors: Erie Lai Har Lau, Redmond, WA (US); Brian Dominguez, Atlanta, GA (US); Sangar Dowlatkhah, Alpharetta, GA (US)

(21) Appl. No.: 15/829,821

(22) Filed: Dec. 1, 2017

(51) Int. Cl. B60R 16/023; H04L 29/08

(52) U.S. Cl. CPC B60R 16/0237; H04W 88/08; H04L 67/306; H04L 67/125

(57) ABSTRACT

Dynamic wireless configuration of a vehicle via a network slice to facilitate improved subscriber experiences is presented herein. A dynamic recommendation engine can comprise a data component and a configuration component. The data component can obtain, via a network slice associated with a virtual network function corresponding to a vehicle service, subscriber profile data comprising preferences of a subscriber of the vehicle service. Further, the data component can obtain, via the network slice, telemetry data from a group of sensors corresponding to a route. Based on the subscriber profile data and the telemetry data, the configuration component can determine, via the network slice, configuration data for a vehicle of the vehicle service, and send, via the network slice using a wireless interface, the configuration data directed to the vehicle to facilitate a selection of a configuration of the vehicle.

### TECHNICAL FIELD

The subject disclosure generally relates to embodiments for dynamic wireless configuration of a vehicle via a network slice.

### BACKGROUND

Conventional vehicle technologies utilize predefined thresholds for configuring a vehicle during its manufacture, including configuration of default parameters for brakes, security alarms, and environmental control devices for a cabin of the vehicle. However, such technologies cannot remotely tailor a vehicle's configuration according to driver/passenger preference(s) in response to various external and/or environmental changes encountered by the vehicle. Consequently, conventional wireless technologies have had some drawbacks, some of which may be noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a connected vehicle wireless communication environment comprising a vehicle service slice and dynamic recommendation engine, in accordance with various example embodiments;

FIG. 2 illustrates a block diagram of a dynamic recommendation engine, in accordance with various example embodiments;

FIG. 3 illustrates a block diagram of a vehicle system, in accordance with various example embodiments;

FIGS. 4-10 illustrate flowcharts of methods associated with a dynamic recommendation engine, in accordance with various example embodiments;

FIG. 11 illustrates a block diagram of a wireless network environment, in accordance various example embodiments; and

FIG. 12 is a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

Conventional vehicle technologies have had some drawbacks with respect to tailoring a transportation experience of a driver/passenger of a vehicle according to preference(s) of the driver/passenger under varying traffic and/or environmental conditions. Various embodiments disclosed herein can improve driver/passenger experiences within a transportation ecosystem by dynamically, e.g., in real-time/near real-time, configuring, via a network slice associated with a virtual network function, a route and/or a cabin environment of a vehicle based on predefined preference(s) of the driver/passenger and determined event(s)/condition(s), e.g., traffic, weather, etc. conditions corresponding to the route; predicted, anticipated, etc. event(s)/condition(s) corresponding to the route, etc.

For example, in an embodiment, a system, e.g., a dynamic recommendation engine, can comprise a data component and a configuration component. The data component can obtain, via a network slice associated with a virtual network function corresponding to a group of software network functions that are associated with respective vehicle services, subscriber profile data comprising preferences of a subscriber (e.g., occupant, driver, passenger) of a vehicle service of the respective vehicle services.

In embodiment(s), the preferences of the subscriber can be defined by the subscriber and represent environmental preferences, e.g., temperature, humidity, etc. of an interior area of the vehicle, entertainment preferences, e.g., music, news, sports, etc. for the interior, and/or other preferences of the subscriber, e.g., preferred number of passengers, a type of the vehicle, etc. In one embodiment, a subscriber interface component can query, via the network slice, the subscriber for the preferences, and store/retrieve the preferences in/from a data store associated with the vehicle service.

Further, the data component can obtain, via the network slice, telemetry data from a group of sensors corresponding to a route, e.g., requested route, designated route, determined route, current route, etc. of the vehicle—the telemetry data representing current, recent, etc. traffic, weather, emergency incident, etc. conditions corresponding to the route, etc. In this regard, in embodiment(s), the data component can obtain the telemetry data from sensor(s) of the vehicle; sensor(s) of other vehicles corresponding to the route; route sensor(s), e.g., cameras, temperature sensors, precipitation sensors, traffic sensors, emergency response based sensors, etc. that have been installed along the route; other route sensor(s) corresponding to other route(s) that are near, adjacent to the route, similar to the route, e.g., with respect to a terrain, an elevation, a climate, a traffic flow, etc. of the route, etc.

In turn, based on the subscriber profile data and the telemetry data, the configuration component can determine, via the network slice, configuration data for the vehicle, and send, via the network slice utilizing a wireless interface communicatively coupling the dynamic recommendation engine to the vehicle, the configuration data directed to a vehicle system of the vehicle to facilitate a selection, by the vehicle system, of a configuration of device(s), component(s), etc. of the vehicle, e.g., steering device(s), acceleration device(s), braking device(s), suspension device(s), etc.—for facilitating autonomous control of an interior environment of the vehicle and/or a route of the vehicle based on real-time/near-real time conditions of the route and preferences of the subscriber.

In one embodiment, the vehicle can comprise an autonomous vehicle, e.g., operating without direct control by a person, e.g., corresponding to an autonomous vehicle service. In another embodiment, the vehicle can correspond to a “for-hire” transportation service, e.g., taxi service, on-line based transportation service, etc. In this regard, in embodiment(s), the subscriber interface component can be configured to receive, via the network slice, a request from the subscriber specifying a defined “pick up” time, a defined pick up location, a defined “drop off” location/destination, etc. corresponding to the autonomous vehicle service, corresponding to the for-hire transportation service, etc.

In yet another embodiment, the dynamic recommendation engine can be configured to detect, via the network slice, a transaction that has been initiated by the subscriber, e.g., an on-line transaction, purchase, etc. of a movie ticket, sporting event ticket, groceries, for-hire transportation service, etc. In turn, the subscriber interface component can be configured to send, via the network slice, a query to the subscriber requesting the subscriber specify a date, time, location, etc. for an autonomous vehicle to pick up the subscriber and transport the subscriber to a destination corresponding to the product/service. Further, the configuration component can determine configuration data for the autonomous vehicle; initiate, based on the configuration data, a selection of the type of autonomous vehicle; and send, via network slice, the configuration data directed to the autonomous vehicle.

In one embodiment, a method can comprise determining, by a system comprising a processor via a virtual network function, configuration information for a vehicle associated with a vehicle service in response to receiving, by the system via the virtual network function, profile information corresponding to a subscriber of the vehicle service and route information corresponding to the vehicle, e.g., the route information comprising telemetry data received from a group of sensors corresponding to a route of the vehicle; and sending, by the system via the virtual network function using a wireless access point device, the configuration information directed to the vehicle to facilitate a change in a configuration of the vehicle.

In embodiment(s), the profile information can comprise environmental preferences for an interior of the vehicle; commute preferences representing whether the subscriber is a commuter, business traveler, tourist, etc.; original equipment manufacturing (OEM) information defining component(s), system(s), communication interface(s), etc. of the vehicle; etc. In other embodiment(s), the configuration information can specify, comprise, etc. a type of the vehicle, an interior environment of the vehicle, a route of the vehicle, etc.

In another embodiment, a machine-readable storage medium can comprise executable instructions that, when executed by a processor, facilitate performance of operations, comprising: in response to receiving request information corresponding to a designated route of a vehicle, obtaining subscriber information representing preferences of a subscriber of a vehicle service corresponding to the vehicle; obtaining sensor data from a group of sensors corresponding to the designated route; and in response to deriving, based on the request information, the subscriber information, and the sensor data, configuration information for the vehicle, wirelessly sending the configuration information directed to the vehicle to facilitate a performance of the vehicle service, e.g., selecting the vehicle for the designated route, modifying a component of the vehicle, modifying a route of the vehicle, etc.

Reference throughout this specification to “one embodiment,” “an embodiment,” etc. means that a particular feature, structure, or characteristic described in connection with the embodiment is included in at least one embodiment. Thus, the appearances of the phrase “in one embodiment,” “in an embodiment,” etc. in various places throughout this specification are not necessarily all referring to the same embodiment. Furthermore, the particular features, structures, or characteristics may be combined in any suitable manner in one or more embodiments.

As mentioned above, conventional vehicle technologies have had some drawbacks with respect to tailoring a transportation experience of a driver/passenger of a vehicle—based on preference(s) of the driver/passenger—under varying traffic and/or environmental conditions. To address these and other concerns of such technologies, various embodiments disclosed herein can improve customer experiences within a transportation ecosystem by monitoring, by a network slice via a sensor network, telemetry data representing, e.g., traffic, weather, etc. conditions of a desired route, and controlling, via the network slice, component(s), a route, etc. of a vehicle based on the telemetry data and predefined preferences of an occupant of the vehicle.

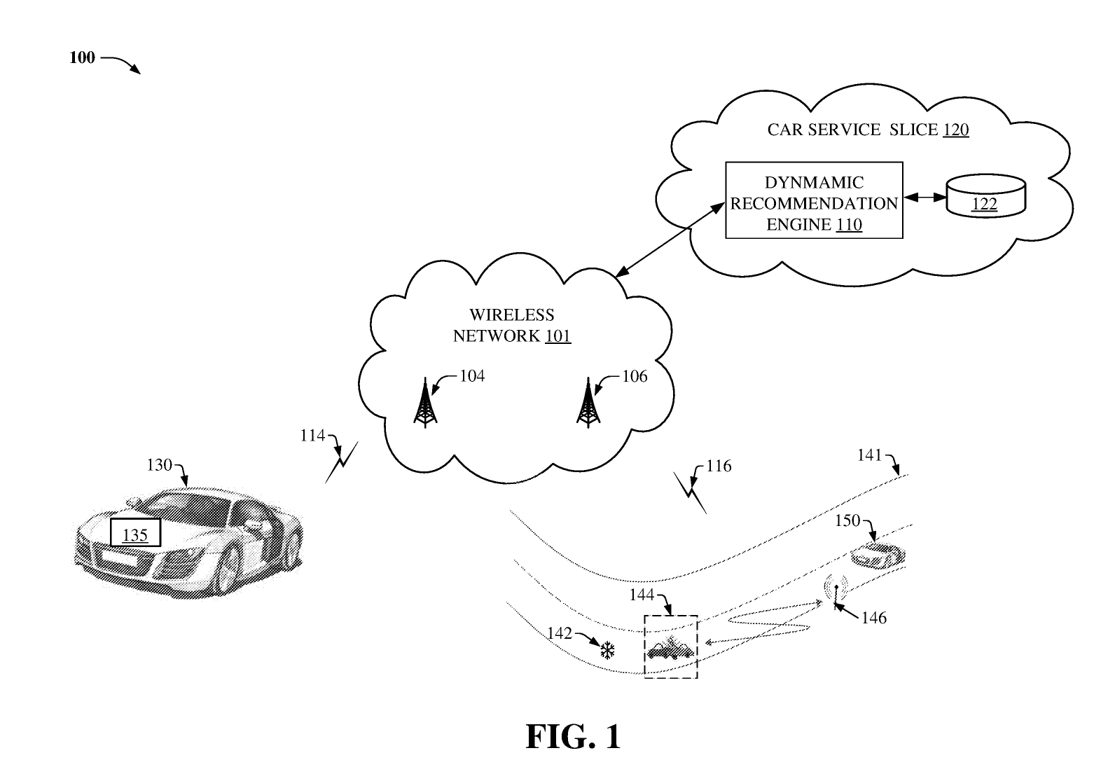

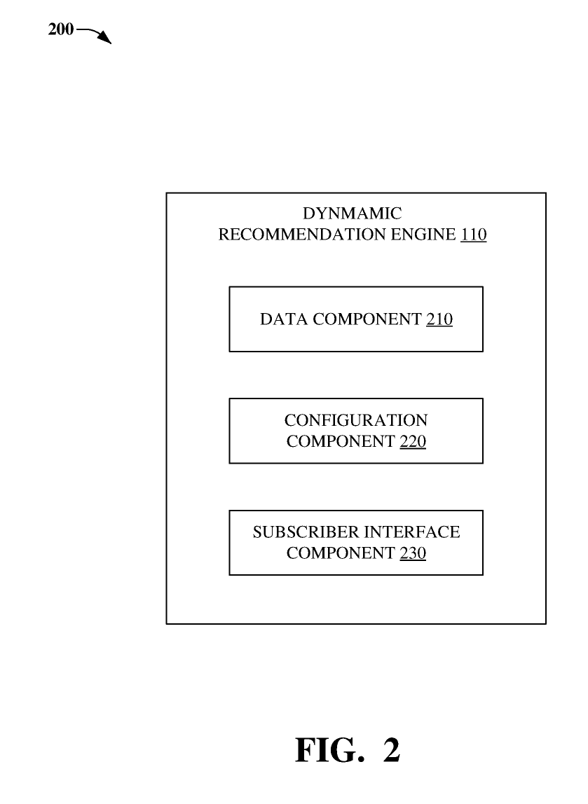

In this regard, and now referring to FIGS. 1 and 2, block diagrams of a “connected vehicle” wireless communication environment (100) comprising a vehicle service slice (120) and a dynamic recommendation engine (110) are illustrated, respectively, in accordance with various example embodiments. Connected vehicle wireless communication environment 100 can comprise a vehicle ecosystem in which vehicles (e.g., 130, 150) are wirelessly connected, via wireless network 101, to dynamic recommendation engine 110 of vehicle service slice 120. Vehicle service slice 120 can comprise a network slice associated with a virtual network function corresponding to a group of software network functions that are associated with respective vehicle services.

In embodiment(s), vehicle service slice 120 can comprise a cloud-based service that facilitates, via dynamic recommendation engine 110, dynamic control of feature(s), operation(s), etc. of a vehicle (e.g., 130, 150) according to preferences that have been defined by a subscriber of the cloud-based service and traffic conditions 144, weather conditions 142, predicted/anticipated conditions, etc. corresponding to route 141—the subscriber being an occupant (driver or passenger) of the vehicle, and route 141 being a current route the vehicle is traveling on, a route designated by the subscriber, a route determined, as described below, based on a transaction, event etc. (e.g., ticket purchase) that has been initiated by the subscriber, etc.

Dynamic recommendation engine 110 comprises data component 210, configuration component 220, and subscriber interface component 230. In this regard, data component 210 can obtain the preferences that have been defined by the subscriber, e.g., as subscriber profile data, from data store 122. Such preferences can comprise environmental preferences, e.g., temperature, humidity, etc. of an interior area, or cabin, of the vehicle; entertainment preferences, e.g., type of music to be played/displayed via audio/visual components of the vehicle, type of radio channels, content, etc. to be played/displayed via the audio components; other preferences, e.g., representing a preferred number of passengers of the vehicle, representing a selection of a type, style, model, etc. of the vehicle for performance of a for-hire cloud-based transportation service, etc. In embodiment(s), subscriber interface component 230 can query, via a user interface (not shown), the subscriber for the preferences, and store the preferences in data store 122.

Further, data component 210 can obtain the telemetry data via a group of sensors, e.g., a ubiquitous sensor network comprising sensor(s) (see 310 below) of the vehicle, sensor(s) (not shown) of other vehicles (150), weather related sensor(s) (142), e.g., temperature sensors, precipitation sensors, etc. corresponding to, installed along, etc. route 141, traffic incident and/or emergency response based sensor(s) (144), e.g., cameras, corresponding to, installed along, etc. route 141; other route sensor(s) (not shown) corresponding to other route(s) that are adjacent to, near, similar to, etc. the route (e.g., with respect to a terrain, an elevation, a climate, and/or a traffic flow), etc. In this regard, the telemetry data can represent current, recent, etc. traffic, weather, emergency incident, etc. conditions corresponding to route 141 and/or the other route(s).

As illustrated by FIG. 1, data component 210 can wirelessly obtain, via wireless network 101, the telemetry data via a wireless interface (e.g., 114, 116) utilizing an access point (AP) (e.g. 104, 106, 146), e.g., a macro AP, a Femto AP, a pico AP, a base station, etc. The wireless interface can comprise an over-the-air wireless link comprising a downlink (DL) and an uplink (UL) (both not shown) that can utilize a predetermined band of radio frequency (RF) spectrum associated with, e.g., cellular, LTE, LTE advanced (LTE-A), GSM, 3GPP universal mobile telecommunication system (UMTS), Institute of Electrical and Electronics Engineers (IEEE) 802.XX technology (WiFi, Bluetooth, etc.), worldwide interoperability for microwave access (WiMax), a wireless local area network (WLAN), Femto, near field communication (NFC), Wibree, Zigbee, satellite, WiFi Direct, etc. Accordingly, wireless network 101 can be associated with RF spectrums corresponding to respective types of wireless technologies including, but not limited to, cellular, WiFi, WiMax, WLAN, Femto, NFC, Wibree, Zigbee, satellite, WiFi Direct, etc.

In embodiment(s), dynamic recommendation engine 110 can be communicatively coupled, via vehicle service slice 120, to wireless network 101 utilizing one or more of the Internet (or another communication network (e.g., an Internet protocol (IP) based network)), a digital subscriber line (DSL)-type or broadband network facilitated by Ethernet or other technology, and/or wireless interface(s), e.g., cellular, WiFi, WiMax, WLAN, Femto, NFC, Wibree, Zigbee, satellite, WiFi Direct, etc. In this regard, components, portions, etc. of “connected vehicle” wireless communication environment 100 can comprise a cloud-based, centralized, communication platform, Internet platform, WAN, etc. (e.g., vehicle service slice 120). In turn, component(s), portion(s), etc. of vehicle service slice 120, e.g., dynamic recommendation engine 110, can be implemented within the cloud-based, centralized, communication platform.

Referring now to FIG. 2, configuration component 220 can determine, based on the telemetry data and the subscriber profile data, configuration data for the vehicle. In turn, configuration component 220 can send, via wireless network 101, the configuration data directed to vehicle system 135 to facilitate an autonomous selection, by vehicle system 135, of a configuration of device(s), component(s), etc. of the vehicle, e.g., heating and/or air conditioning device(s), entertainment device(s), etc. based on real-time/near real time environmental conditions of route 141 and preferences of the subscriber.

For example, in an embodiment, if the preferences of the subscriber define that the subscriber prefers a temperature of an interior of the vehicle to be within a couple of degrees of 70°, vehicle system 135 can control, based on the configuration data, the heating and/or air conditioning device(s), component(s), etc. of the vehicle to maintain the temperature of the interior of the vehicle to be 70°±2°—without manual control by the occupant, e.g., driver, of the vehicle.

In another embodiment, if the preferences of the subscriber define that during a particular time of day, e.g., morning commute, the subscriber prefers a particular genre, type, etc. of music, a particular news channel, etc. to be played within the vehicle, vehicle system 135 can control, based on the configuration data, the radio of the vehicle to select a music station, news station, etc. corresponding to the subscriber preferences during the morning commute—without manual control by the driver.

In other embodiment(s), the vehicle can comprise an autonomous vehicle, e.g., operating without direct control by a person, and vehicle service slice 120 can correspond to an autonomous vehicle service. In turn, the configuration data can specify information for control, modification, etc., e.g., via vehicle system 135, of steering device(s), acceleration device(s), braking device(s), suspension device(s), etc. of the autonomous vehicle, e.g., for controlling travel of the vehicle along route 141, or along a different route corresponding to a defined destination of route 141, e.g., based on current, recent, etc. traffic information, weather conditions, etc. represented by the telemetry data.

For example, in one embodiment, if the preferences of the subscriber of the autonomous vehicle service define that the subscriber is a commuter, e.g., to work, school, etc., configuration component 220 can determine, based on the telemetry data representing, e.g., current weather conditions, traffic conditions, road conditions, emergency incidents, etc., the configuration data representing an optimal, e.g., shortest, route, detour from route 141, etc. corresponding to the destination. In turn, vehicle system 135 can control device(s), component(s), etc. of the vehicle—without manual control by the occupant, e.g., passenger, of the vehicle—to transport the passenger, via the optimal route, detour, etc., to the destination.

In other embodiment(s), if the preferences of the subscriber of the autonomous vehicle service define that the subscriber is a tourist, configuration component 220 can determine, based on the telemetry data, the configuration data representing a tourist route, detour from route 141, etc. corresponding to tourist attractions that can be traveled to on the way to the destination. In turn, vehicle system 135 can control device(s), component(s), etc. of the vehicle—without manual control by the occupant, e.g., passenger, of the vehicle—to transport the passenger, via the tourist route, detour, etc., to the destination.

In yet other embodiment(s), the vehicle, e.g., autonomous vehicle, can correspond to a for-hire transportation service, e.g., taxi service, on-line based transportation service, etc. In this regard, subscriber interface component 230 can be configured to receive, via wireless network 101, e.g., from a mobile device, cell phone, portable computing device, etc. corresponding to the subscriber, a request from the subscriber specifying a defined route/destination (e.g., along route 141), pick up time, pick up location, etc. In turn, based on the request, data component 210 can obtain, via the wireless interface (e.g., 114, 116), the telemetry data from the group of sensors corresponding to route 141.

Further, based on the subscriber profile data (e.g., representing a preferred cabin environment, number of passengers, type of vehicle, etc.) and the telemetry data (e.g., representing current weather conditions, traffic conditions, road conditions, emergency incidents, etc.), configuration component 220 can determine configuration data for the autonomous vehicle corresponding to the for-hire transportation service. In this regard, in embodiment(s), dynamic recommendation engine 110 can initiate, based on the configuration data, a selection of the type of autonomous vehicle, and send, via wireless network 101, the configuration data directed to a vehicle system (e.g., 135) of the type of autonomous vehicle corresponding to the for-hire transportation service, e.g., for facilitating autonomous control of an interior environment of the vehicle based on the subscriber profile data and real-time/near-real time conditions of the route represented by the telemetry data.

In another embodiment, dynamic recommendation engine 110 can be configured to detect, via vehicle service slice 120, a transaction that has been initiated by the subscriber, e.g., an on-line transaction, purchase, etc. of a product/service, e.g., purchase of a movie ticket, sporting event ticket, groceries, for-hire transportation service, etc. In turn, subscriber interface component 230 can be configured to send, via vehicle service slice 120, a query to the subscriber requesting the subscriber specify a date, time, location, etc. for an autonomous vehicle to pick up the subscriber and transport the subscriber to a destination corresponding to the product/service, e.g., the destination determined, by dynamic recommendation engine 110, based on the transaction. Further, as described above, configuration component 220 can determine configuration data for the autonomous vehicle; initiate, based on the configuration data, a selection of the type of autonomous vehicle; and send, via wireless network 101, the configuration data directed to the vehicle system of the autonomous vehicle.

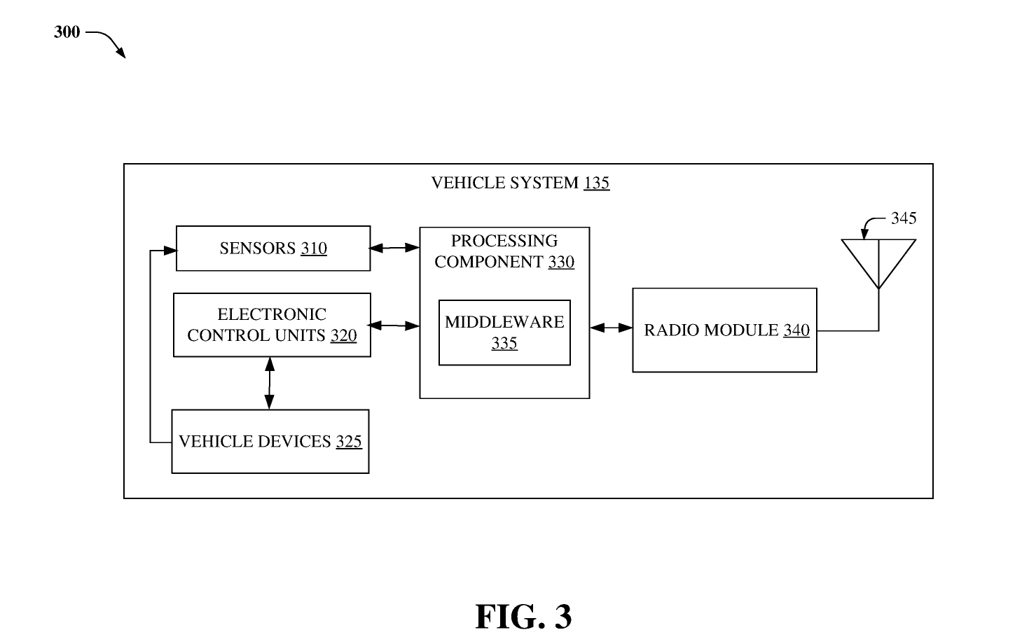

Now referring to FIG. 3, a block diagram (300) of a vehicle system (135) comprising sensors (310), electronic control units (320), vehicle devices (325), a processing component (330) comprising middleware (335), a radio module (340), and antenna(s) (345) is illustrated, in accordance with various embodiments. In this regard, middleware 335 comprises computer-readable media for storing instructions that can be executed by processing component 330 for performing various operations of a vehicle, an autonomous vehicle, etc. (e.g., 130, 150). In embodiment(s), the operations can comprise receiving, via a wireless interface (e.g., 114, 116) using radio module 340 and antenna(s) 345, configuration data from dynamic recommendation engine 110, and controlling, based on the configuration data, vehicle devices 325, e.g., climate control devices, suspension devices, acceleration devices, braking devices, navigation devices, warning devices, entertainment devices, etc.

Further, the operations can comprise receiving telemetry data, e.g., representing road, weather, traffic, etc. conditions from sensors 310, and sending, via the wireless interface using radio module 340 and antenna(s) 345, the telemetry data to dynamic recommendation engine 110. In embodiment(s), radio module 340 can comprise a long-term evolution (LTE) based radio module corresponding to new radio access technology, e.g., operable from sub-gigahertz (GHz), e.g., 1 GHz, to 100 GHz. In other embodiment(s), middleware 335 can comprise OEM firmware for configuring, controlling, etc. electronic control units 320 corresponding to respective devices of vehicle devices 325.

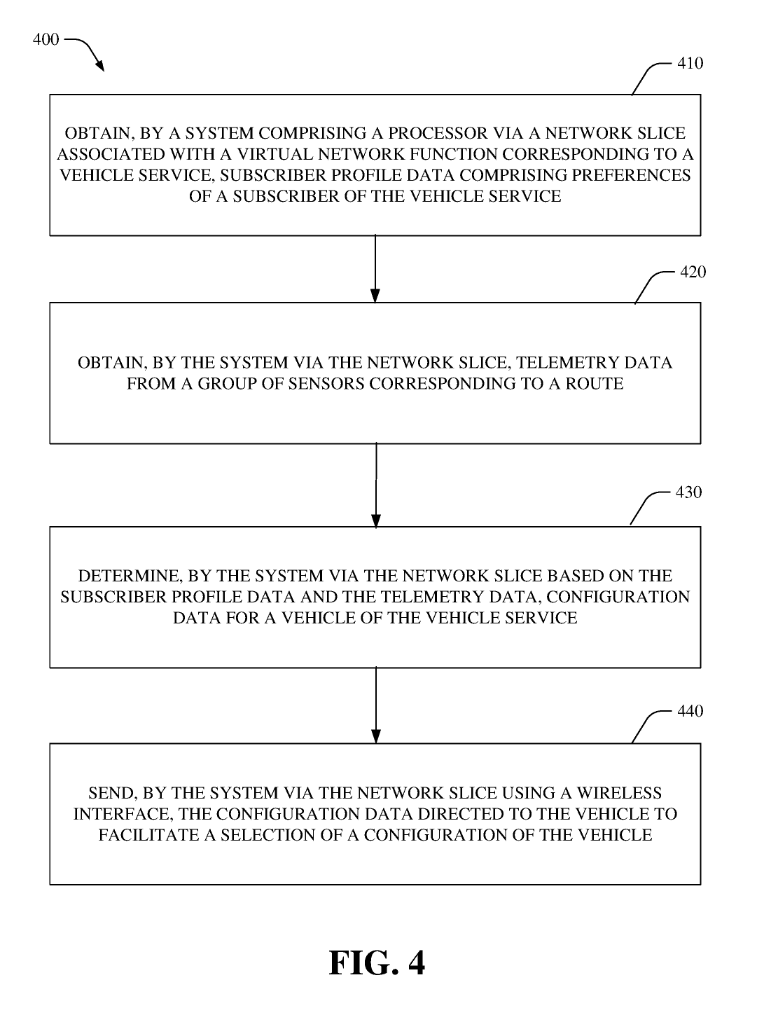

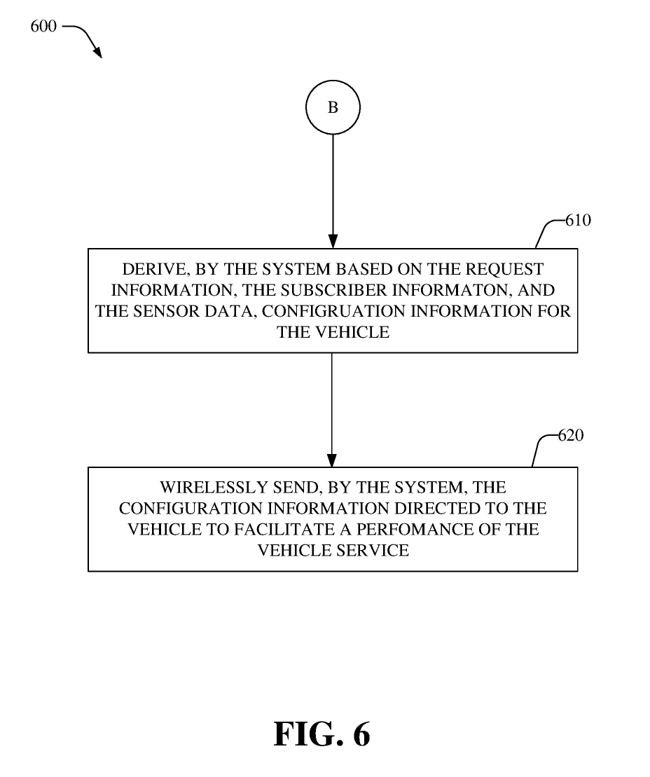

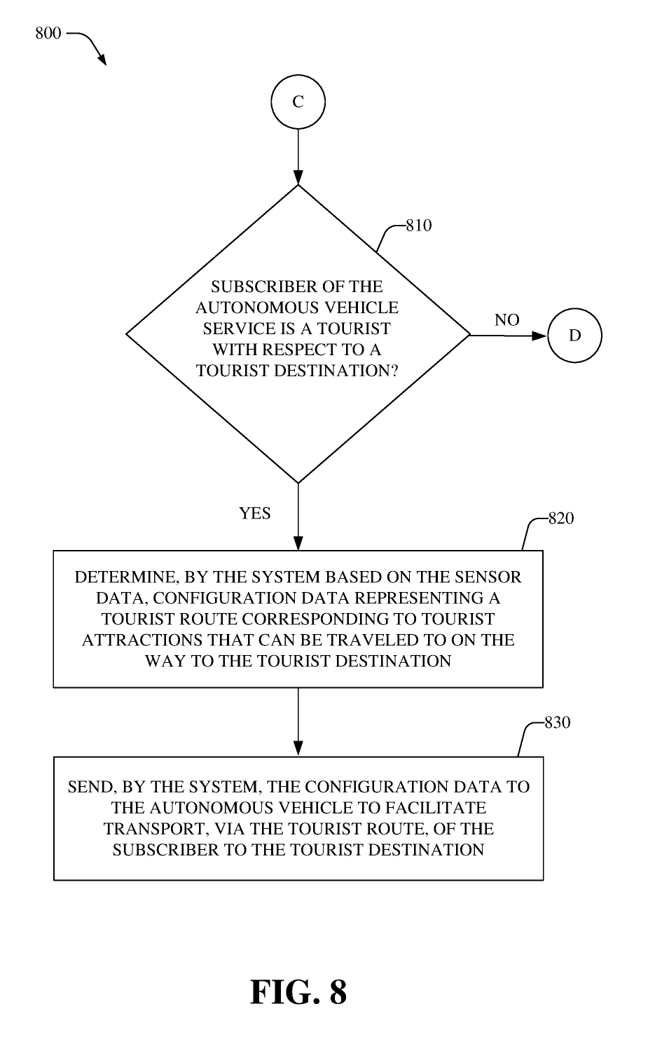

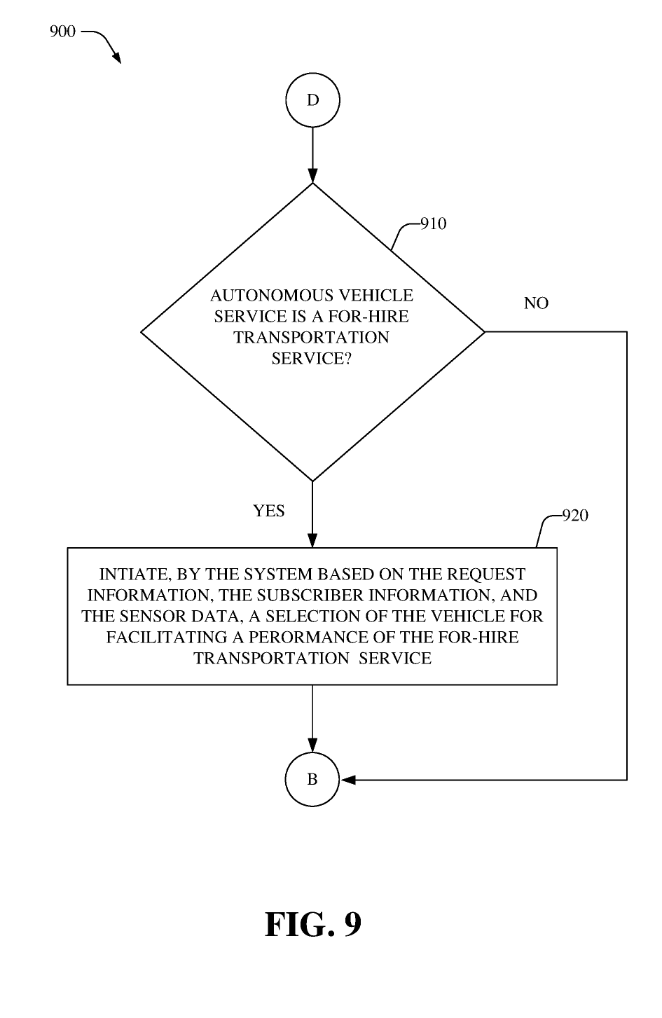

FIGS. 4-10 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 4, a process (400) performed by a system, e.g., dynamic recommendation engine 110, is illustrated, in accordance with various example embodiments. At 410, the system can obtain, via a network slice associated with a virtual network function corresponding to a vehicle service, subscriber profile data comprising preferences of a subscriber of the vehicle service. At 420, the system can obtain, via the network slice, telemetry data from a group of sensors corresponding to a route. At 430, the system can determine, via the network slice based on the subscriber profile data and the telemetry data, configuration data for a vehicle of the vehicle service. At 440, the system can send, via the network slice using a wireless interface, the configuration data directed to the vehicle to facilitate a selection of a configuration of the vehicle.

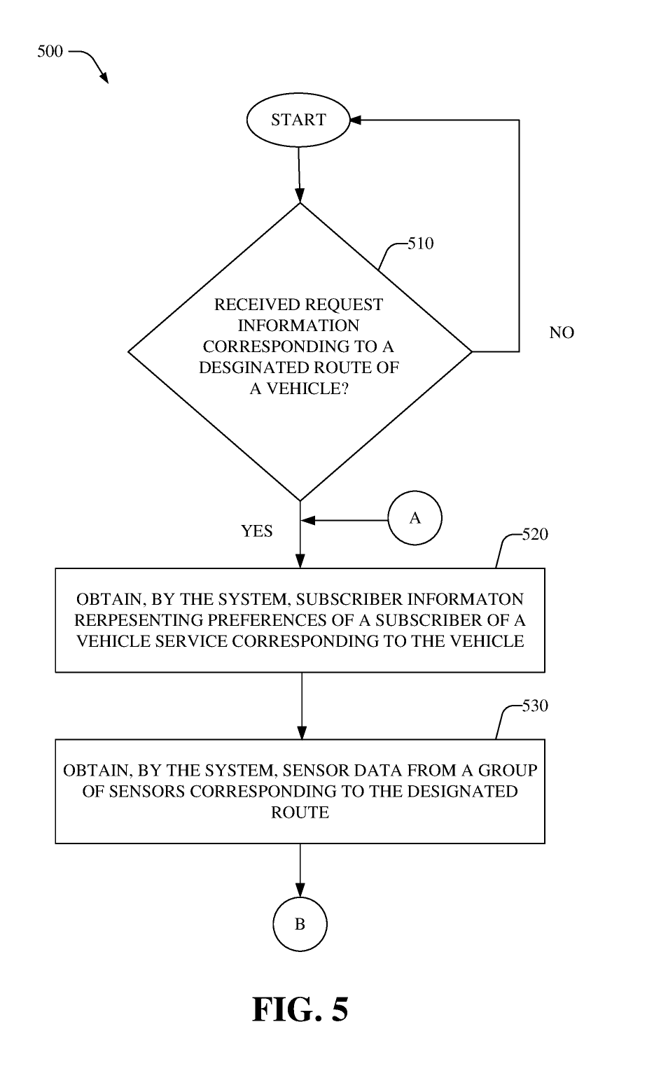

FIGS. 5-10 illustrate flowcharts of methods associated with a system, e.g., dynamic recommendation engine 110, in accordance with various embodiments. At 510, the system can determine whether request information corresponding to a defined, designated, etc. route of a vehicle, e.g., an autonomous vehicle, a vehicle for-hire, etc. has been received. At 510, if it is determined that the request information has been received, flow continues to 520, at which the system can obtain subscriber information representing preferences of a subscriber of a vehicle service, e.g., autonomous vehicle service, for-hire vehicle service, etc. corresponding to the vehicle; otherwise flow returns to 510.

Flow continues from 520 to 530, at which the system can obtain sensor data from a group of sensors corresponding to the defined, designated, etc. route of the vehicle. In turn, flow continues from 530 to 610, at which the system can derive, based on the request information, the subscriber information, and the sensor data, configuration information for the vehicle. Further, flow continues from 610 to 620, at which the system can wirelessly send the configuration information directed to the vehicle to facilitate a performance of the vehicle service.

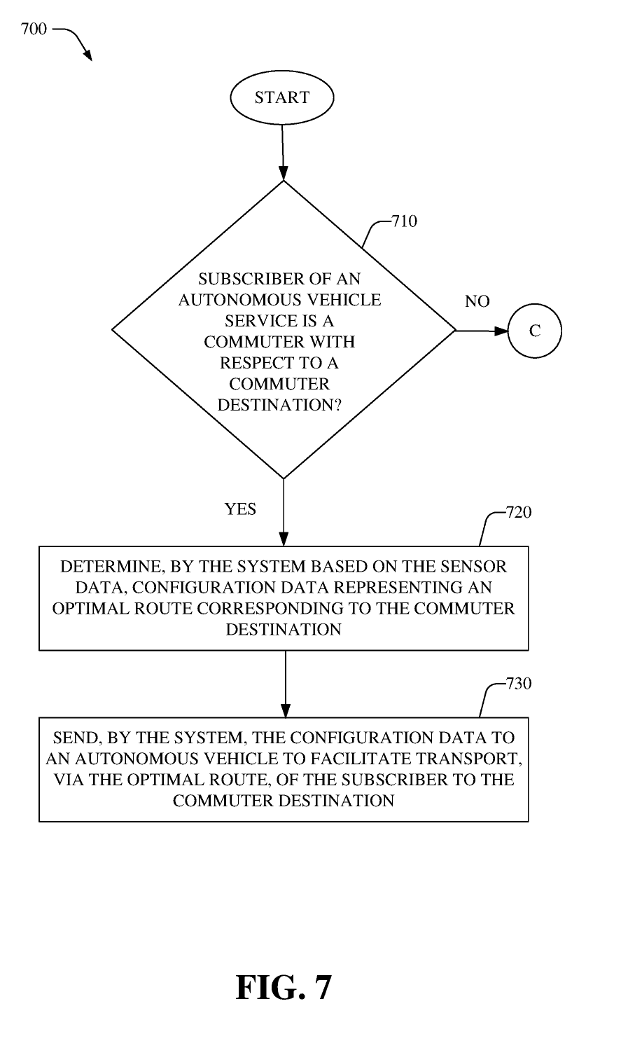

Now referring to FIG. 7, in response to a determination, by the system, that the subscriber has subscribed to an autonomous vehicle service, and is a commuter with respect to a destination, commuter destination, etc. (e.g., work, school, etc.), flow continues from 710 to 720, at which the system can determine, based on the sensor data, configuration data representing an optimal, e.g., fastest, route corresponding to the destination, commuter destination, etc.; otherwise flow continues to 810. Flow continues from 720 to 730, at which the system can send the configuration data to an autonomous vehicle to facilitate transport, via the optimal route, of the subscriber to the destination, commuter destination, etc.

At 810, the system can determine whether the subscriber of the autonomous vehicle service is a tourist with respect to a destination, tourist destination, etc. In this regard, in response to a determination that the subscriber of the autonomous vehicle service is a tourist, flow continues to 820, at which the system can determine, based on the sensor data, configuration data representing a tourist route corresponding to tourist attractions that can be traveled to on the way to the destination, tourist destination, etc.; otherwise flow continues to 910. Flow continues from 820 to 830, at which the system can send the configuration data to the autonomous vehicle to facilitate transport, via the tourist route, of the subscriber to the destination, tourist destination, etc.

At 910, the system can determine whether the autonomous vehicle service is a for-hire transportation service. In this regard, in response to a determination that the autonomous vehicle service is a for-hire transportation service, flow continues to 920; otherwise flow returns to 610. At 920, the system can initiate, based on the request information, the subscriber information, and the sensor data, a selection of the vehicle for facilitating a performance of the for-hire transportation service. Further, flow continues from 920 to 610.

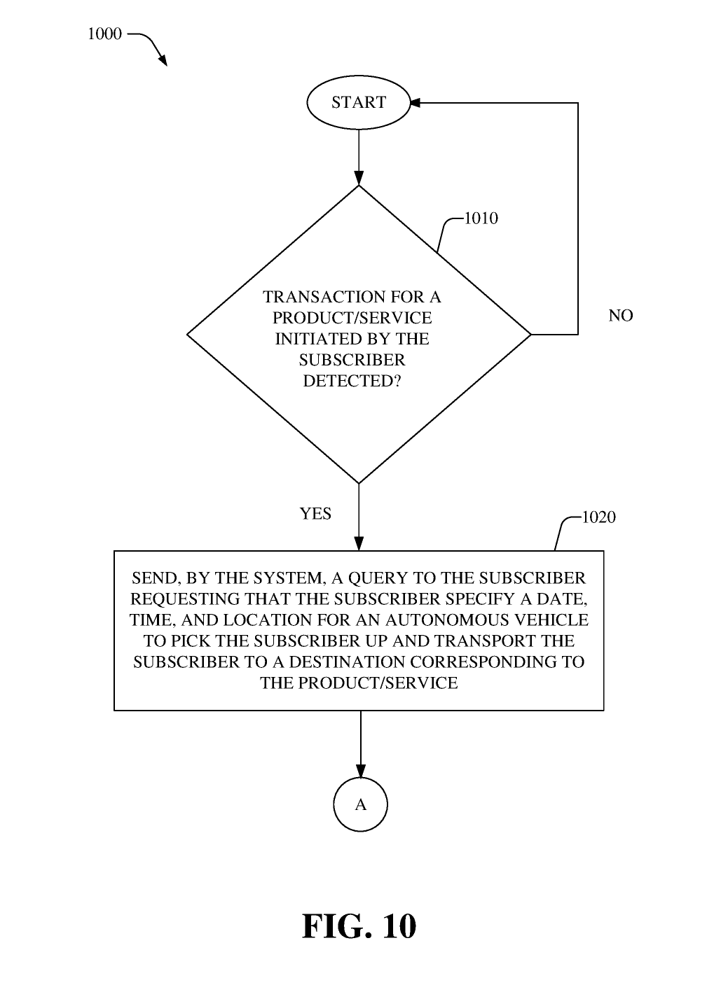

Referring now to FIG. 10, at 1010, the system can determine whether a transaction for a product/service that has been initiated by the subscriber has been detected. In this regard, in response to a determination that the transaction for the product/service that has been initiated by the subscriber has been detected, flow continues to 1020, at which the system can send, via subscriber interface component 230, a query to the subscriber requesting that that subscriber specify a date, time, and location for an autonomous vehicle to pick the subscriber up and transport the subscriber to a destination corresponding to the product/service. Further, flow returns to 520 from 1020.

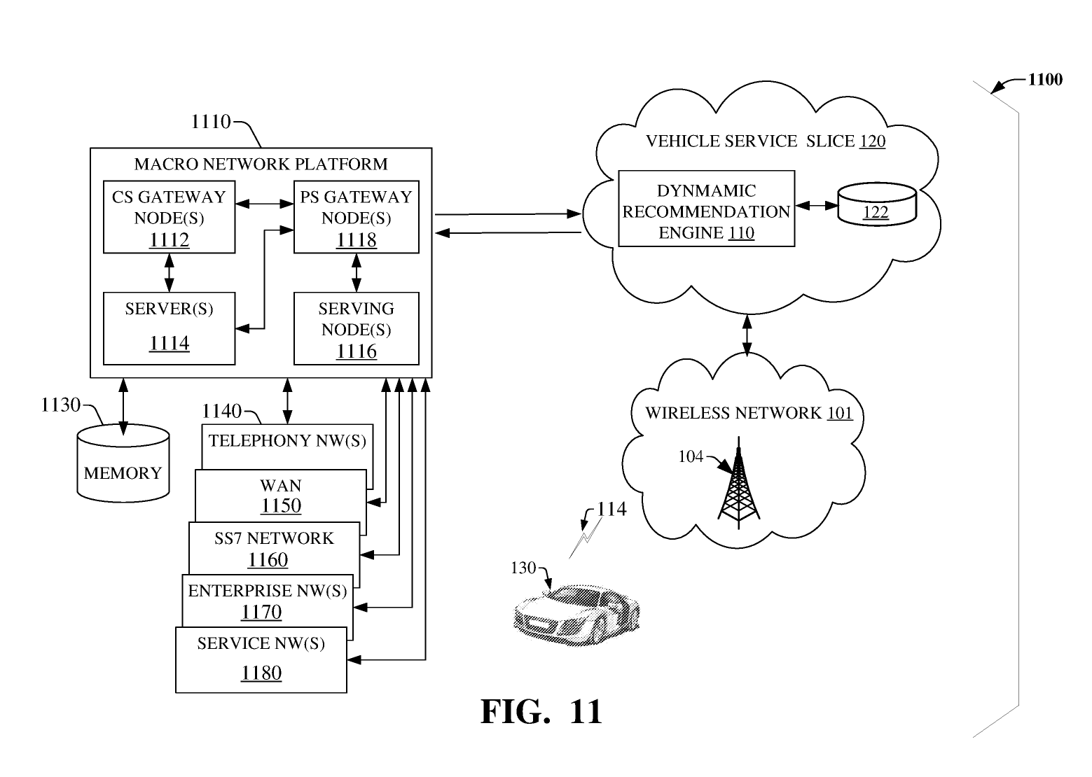

With respect to FIG. 11, a wireless communication environment 1100 including macro network platform 1110 is illustrated, in accordance with various embodiments. Macro network platform 1110 serves or facilitates communication with a vehicle system (e.g., 135) of a vehicle (e.g., 130, 150) and vehicle service slice 120 via wireless network 101. It should be appreciated that in cellular wireless technologies, e.g., 3GPP UMTS, high speed packet access (HSPA), 3GPP LTE, third generation partnership project 2 (3GPP2), ultra-mobile broadband (UMB), LTE-A, etc. that can be associated with wireless network 101, macro network platform 1110 can be embodied in a core network. It is noted that wireless network 101 can include base station(s) (e.g., 104, 106), base transceiver station(s), access point(s), etc. and associated electronic circuitry and deployment site(s), in addition to a wireless radio link (e.g., 114, 116) operated in accordance with the base station(s), etc. Accordingly, wireless network 101 can comprise various coverage cells, or wireless coverage areas. In addition, it should be appreciated that elements and/or components (e.g., dynamic recommendation engine 110, data store 122) of vehicle service slice 120 can be located/included within one or more components/elements, e.g., hardware, software, etc., of wireless communication environment 1100, e.g., macro network platform 1110, wireless network 101, etc.

Generally, macro network platform 1110 includes components, e.g., nodes, GWs, interfaces, servers, platforms, etc. that facilitate both packet-switched (PS), e.g., IP, frame relay, asynchronous transfer mode (ATM), and circuit-switched (CS) traffic, e.g., voice and data, and control generation for networked wireless communication, e.g., via dynamic recommendation engine 110. In various embodiments, macro network platform 1110 includes CS gateway (GW) node(s) 1112 that can interface CS traffic received from legacy networks like telephony network(s) 1140, e.g., public switched telephone network (PSTN), public land mobile network (PLMN), Signaling System No. 7 (SS7) network 1160, etc. CS GW node(s) 1112 can authorize and authenticate traffic, e.g., voice, arising from such networks. Additionally, CS GW node(s) 1112 can access mobility or roaming data generated through SS7 network 1160; for instance, mobility data stored in a visitor location register (VLR), which can reside in memory 1130. Moreover, CS GW node(s) 1112 interfaces CS-based traffic and signaling with PS GW node(s) 1118. As an example, in a 3GPP UMTS network, PS GW node(s) 1118 can be embodied in GW general packet radio service (GPRS) support node(s) (GGSN).

As illustrated by FIG. 11, PS GW node(s) 1118 can receive and process CS-switched traffic and signaling via CS GW node(s) 1112. Further PS GW node(s) 1118 can authorize and authenticate PS-based data sessions, e.g., via wireless network 101, with served devices, communication devices, etc. Such data sessions can include traffic exchange with networks external to macro network platform 1110, like wide area network(s) (WANs) 1150; enterprise networks (NWs) 1170, e.g., E911, service NW(s) 1180, e.g., an IP multimedia subsystem (IMS), etc. It should be appreciated that local area network(s) (LANs), which may be a part of enterprise NW(s) 1170, can also be interfaced with macro network platform 1110 through PS GW node(s) 1118. PS GW node(s) 1118 can generate packet data contexts when a data session is established, e.g., associated with an EPS bearer context activation. To that end, in an aspect, PS GW node(s) 1118 can include a tunnel interface, e.g., tunnel termination GW (TTG) in 3GPP UMTS network(s) (not shown), which can facilitate packetized communication with disparate wireless network(s), such as Wi-Fi networks. It should be further appreciated that the packetized communication can include multiple flows that can be generated through server(s) 1114. It is to be noted that in 3GPP UMTS network(s), PS GW node(s) 1118 (e.g., GGSN) and tunnel interface (e.g., TTG) comprise a packet data GW (PDG).

Macro network platform 1110 also includes serving node(s) 1116 that can convey the various packetized flows of information, or data streams, received through PS GW node(s) 1118. As an example, in a 3GPP UMTS network, serving node(s) can be embodied in serving GPRS support node(s) (SGSN).

As indicated above, server(s) 1114 in macro network platform 1110 can execute numerous applications, e.g., messaging, location services, wireless device management, etc. that can generate multiple disparate packetized data streams or flows; and can manage such flows, e.g., schedule, queue, format. Such application(s), for example can include add-on features to standard services provided by macro network platform 1110. Data streams can be conveyed to PS GW node(s) 1118 for authorization/authentication and initiation of a data session, and to serving node(s) 1116 for communication thereafter. Server(s) 1114 can also effect security, e.g., implement one or more firewalls, of macro network platform 1110 to ensure network's operation and data integrity in addition to authorization and authentication procedures that CS GW node(s) 1112 and PS GW node(s) 1118 can enact. Moreover, server(s) 1114 can provision services from external network(s), e.g., WAN 1150, or global positioning system (GPS) network(s), which can be a part of enterprise NW(s) 1180. It is to be noted that server(s) 1114 can include one or more processors configured to confer at least in part the functionality of macro network platform 1110. To that end, the one or more processors can execute code instructions stored in memory 1130, for example.

In wireless communication environment 1100, memory 1130 can store information related to operation of macro network platform 1110, e.g., related to operation of a vehicle (e.g., 130, 150), dynamic recommendation engine 110, etc. The information can include data, business data, etc. associated with subscribers of respective services; market plans and strategies, e.g., promotional campaigns, business partnerships, mobile devices served through macro network platform, etc.; service and privacy information, policies, etc.; end-user service logs for law enforcement; term(s) and/or condition(s) associated with wireless service(s) provided via wireless network 101; and so forth. Memory 1130 can also store information from at least one of telephony network(s) 1140, WAN 1150, SS7 network 1160, enterprise NW(s) 1170, or service NW(s) 1180.

In one or more embodiments, components of core network environment 1100 can provide, e.g., via vehicle service slice 120, communication services to the vehicle utilizing an over-the-air wireless link (e.g., 114, 116) via wireless network 101. In this regard, wireless network 101 can include one or more: macro, Femto, or pico access points (APs) (not shown); base stations (BS) (not shown); landline networks (e.g., optical landline networks, electrical landline networks) (not shown) communicatively coupled between the vehicle and macro network platform 1110, etc.

Core network environment 1100 can include one or more of the Internet (or another communication network (e.g., IP-based network)), or DSL-type or broadband network facilitated by Ethernet or other technology. In various embodiments, core network environment 1100 can include hardware and/or software for allocating resources to the vehicle and dynamic recommendation engine 110, converting or enforcing protocols, establishing and/or providing levels of quality of service (QoS), providing applications or services, translating signals, and/or performing other desired functions to facilitate system interoperability and communication to/from the vehicle and dynamic recommendation engine 110.

In other embodiment(s), core network environment 1100 can include data store component(s), a memory configured to store information, computer-readable storage media storing computer-executable instructions, e.g., memory 1130, etc. enabling various operations performed via dynamic recommendation engine as described herein.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “middleware,” “memory storage,” and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in data store 122, middleware 335, memory 1130, non-volatile memory 1222 (see below), disk storage 1224 (see below), and/or memory storage 1246 (see below). Further, nonvolatile memory can be included in read only memory (ROM), programmable ROM (PROM), electrically programmable ROM (EPROM), electrically erasable ROM (EEPROM), or flash memory. Volatile memory 1220 can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

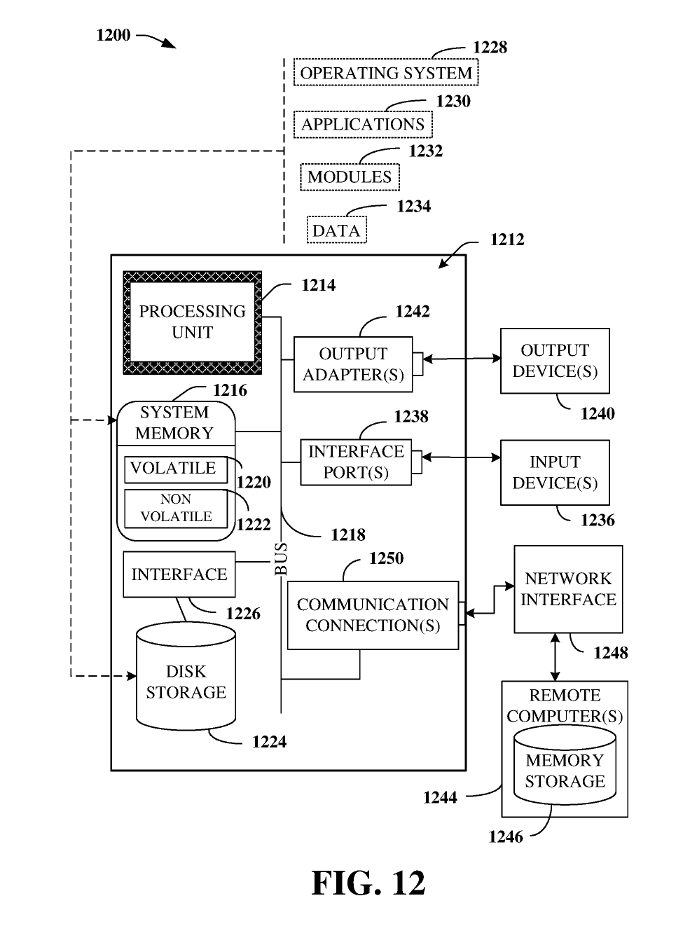

In order to provide a context for the various aspects of the disclosed subject matter, FIG. 12, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 12, a block diagram of a computing system 1200 operable to execute the disclosed systems and methods is illustrated, in accordance with an embodiment. Computer 1212 includes a processing unit 1214, a system memory 1216, and a system bus 1218. System bus 1218 couples system components including, but not limited to, system memory 1216 to processing unit 1214. Processing unit 1214 can be any of various available processors. Dual microprocessors and other multiprocessor architectures also can be employed as processing unit 1214.

System bus 1218 can be any of several types of bus structure(s) including a memory bus or a memory controller, a peripheral bus or an external bus, and/or a local bus using any variety of available bus architectures including, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1216 includes volatile memory 1220 and nonvolatile memory 1222. A basic input/output system (BIOS), containing routines to transfer information between elements within computer 1212, such as during start-up, can be stored in nonvolatile memory 1222. By way of illustration, and not limitation, nonvolatile memory 1222 can include ROM, PROM, EPROM, EEPROM, or flash memory. Volatile memory 1220 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example, disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to system bus 1218, a removable or non-removable interface is typically used, such as interface 1226.

It is to be appreciated that FIG. 12 describes software that acts as an intermediary between users and computer resources described in suitable operating environment 1200. Such software includes an operating system 1228. Operating system 1228, which can be stored on disk storage 1224, acts to control and allocate resources of computer system 1212. System applications 1230 take advantage of the management of resources by operating system 1228 through program modules 1232 and program data 1234 stored either in system memory 1216 or on disk storage 1224. It is to be appreciated that the disclosed subject matter can be implemented with various operating systems or combinations of operating systems.

A user can enter commands or information into computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1214 through system bus 1218 via interface port(s) 1238. Interface port(s) 1238 include, for example, a serial port, a parallel port, a game port, a universal serial bus (USB), a wireless based port, e.g., WiFi, Bluetooth, etc. Output device(s) 1240 use some of the same type of ports as input device(s) 1236.

Thus, for example, a USB port can be used to provide input to computer 1212 and to output information from computer 1212 to an output device 1240. Output adapter 1242 is provided to illustrate that there are some output devices 1240, like display devices, light projection devices, monitors, speakers, and printers, among other output devices 1240, which use special adapters. Output adapters 1242 include, by way of illustration and not limitation, video and sound devices, cards, etc. that provide means of connection between output device 1240 and system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. Remote computer(s) 1244 can be a personal computer, a server, a router, a network PC, a workstation, a microprocessor based appliance, a peer device, or other common network node and the like, and typically includes many or all of the elements described relative to computer 1212.

For purposes of brevity, only a memory storage device (e.g., 1246) is illustrated with remote computer(s) 1244. Remote computer(s) 1244 is logically connected to computer 1212 through a network interface 1248 and then physically and/or wirelessly connected via communication connection 1250. Network interface 1248 encompasses wire and/or wireless communication networks such as local-area networks (LAN) and wide-area networks (WAN). LAN technologies include fiber distributed data interface (FDDI), copper distributed data interface (CDDI), Ethernet, token ring and the like. WAN technologies include, but are not limited to, point-to-point links, circuit-switching networks like integrated services digital networks (e.g., ISDN) and variations thereon, packet switching networks, and digital subscriber lines (DSL).

Communication connection(s) 1250 refer(s) to hardware/software employed to connect network interface 1248 to bus 1218. While communication connection 1250 is shown for illustrative clarity inside computer 1212, it can also be external to computer 1212. The hardware/software for connection to network interface 1248 can include, for example, internal and external technologies such as modems, including regular telephone grade modems, cable modems and DSL modems, wireless modems, ISDN adapters, and Ethernet cards.

The computer 1212 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1212 can connect to other devices/networks by way of antenna, port, network interface adaptor, wireless access point, modem, and/or the like.

The computer 1212 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This includes at least WiFi and Bluetooth wireless technologies. Thus, the communication can be a predefined structure as with a conventional network or simply an ad hoc communication between at least two devices.

WiFi allows connection to the Internet from a desired location (e.g., a vehicle, couch at home, a bed in a hotel room, or a conference room at work, etc.) without wires. WiFi is a wireless technology similar to that used in a cell phone that enables such devices, e.g., mobile phones, computers, etc., to send and receive data indoors and out, anywhere within the range of a base station. WiFi networks use radio technologies called IEEE 802.11 (a, b, g, etc.) to provide secure, reliable, fast wireless connectivity. A WiFi network can be used to connect devices (e.g., mobile phones, computers, etc.) to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

As utilized herein, terms “component,” “system,” “server,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Further, aspects, features, and/or advantages of the disclosed subject matter can be exploited in substantially any wireless telecommunication or radio technology, e.g., IEEE 802.XX technology, e.g., Wi-Fi, Bluetooth, etc.; WiMAX; enhanced GPRS; 3GPP LTE; 3GPP2; UMB; 3GPP UMTS; HSPA; high speed downlink packet access (HSDPA); high speed uplink packet access (HSUPA); LTE-A, GSM, NFC, Wibree, Zigbee, satellite, Wi-Fi Direct, etc.

Further, selections of a radio technology, or radio access technology, can include second generation (2G), third generation (3G), fourth generation (4G), fifth generation (5G), x^{th} generation, etc. evolution of the radio access technology; however, such selections are not intended as a limitation of the disclosed subject matter and related aspects thereof. Further, aspects, features, and/or advantages of the disclosed subject matter can be exploited in disparate electromagnetic frequency bands. Moreover, one or more embodiments described herein can be executed in one or more network elements, such as a mobile wireless device, e.g., UE, and/or within one or more elements of a network infrastructure, e.g., radio network controller, wireless access point (AP), etc.

Moreover, terms like “user equipment,” (UE) “mobile station,” “mobile subscriber station,” “access terminal,” “terminal”, “handset,” “appliance,” “machine,” “wireless communication device,” “cellular phone,” “personal digital assistant,” “smartphone,” “wireless device”, and similar terminology refer to a wireless device, or wireless communication device, which is at least one of (1) utilized by a subscriber of a wireless service, or communication service, to receive and/or convey data associated with voice, video, sound, and/or substantially any data-stream or signaling-stream; or (2) utilized by a subscriber of a voice over IP (VoIP) service that delivers voice communications over IP networks such as the Internet or other packet-switched networks. Further, the foregoing terms are utilized interchangeably in the subject specification and related drawings.

A communication network, e.g., corresponding to a connected vehicle wireless communication environment comprising a vehicle service slice and dynamic recommendation engine, (see e.g., 100), for systems, methods, and/or apparatus disclosed herein can include any suitable mobile and/or wireline-based circuit-switched communication network including a GSM network, a time division multiple access (TDMA) network, a code division multiple access (CDMA) network, such as an Interim Standard 95 (IS-95) and subsequent iterations of CDMA technology, an integrated digital enhanced network (iDEN) network and a PSTN. Further, examples of the communication network can include any suitable data packet-switched or combination data packet/circuit-switched communication network, wired or wireless IP network such as a VoLTE network, a VoIP network, an IP data network, a UMTS network, a GPRS network, or other communication networks that provide streaming data communication over IP and/or integrated voice and data communication over combination data packet/circuit-switched technologies.

Similarly, one of ordinary skill in the art will appreciate that a wireless system e.g., a wireless communication device, vehicle system 135, etc. for systems, methods, and/or apparatus disclosed herein can include a mobile device, a mobile phone, a 4G, a 5G, etc. cellular communication device, a PSTN phone, a cellular communication device, a cellular phone, a satellite communication device, a satellite phone, a VoIP phone, WiFi phone, a dual-mode cellular/WiFi phone, a combination cellular/VoIP/WiFi/WiMAX phone, a portable computer, or any suitable combination thereof. Specific examples of a wireless system can include, but are not limited to, a cellular device, such as a GSM, TDMA, CDMA, IS-95 and/or iDEN phone, a cellular/WiFi device, such as a dual-mode GSM, TDMA, IS-95 and/or iDEN/VoIP phones, UMTS phones, UMTS VoIP phones, or like devices or combinations thereof.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc (BD)); smart card(s); and flash memory device(s) (e.g., card, stick, key drive); and/or a virtual device that emulates a storage device and/or any of the above computer-readable media.

In accordance with various aspects of the subject specification, artificial intelligence based systems, components, etc. can employ classifier(s) that are explicitly trained, e.g., via a generic training data, via policy rules of a policy framework, etc. as well as implicitly trained, e.g., via observing characteristics of communication equipment, e.g., a gateway, a wireless communication device, etc., by receiving reports from such communication equipment, by receiving operator preferences, by receiving historical information, by receiving extrinsic information, etc.

For example, support vector machines can be configured via a learning or training phase within a classifier constructor and feature selection module, component, etc. Thus, the classifier(s) can be used by an artificial intelligence system to automatically learn and perform a number of functions, e.g., performed by a system (e.g., dynamic recommendation engine 110), including but not limited to: obtaining, via a network slice associated with a virtual network function corresponding to a vehicle service, subscriber profile data comprising preferences of a subscriber of the vehicle service; obtaining, via the network slice, telemetry data from a group of sensors corresponding to a route; based on the subscriber profile data and the telemetry data, determining, via the network slice, configuration data for a vehicle of the vehicle service; and sending, via the network slice using a wireless interface, the configuration data directed to the vehicle to facilitate a selection of a configuration of the vehicle.

In one embodiment, the classifier(s) can be used by the artificial intelligence system to automatically determine, predict, anticipate, etc. event(s)/condition(s), e.g., poor traffic conditions corresponding to the route, e.g., based on the telemetry data indicating reduced traffic conditions, e.g., increased traffic, icy and/or wet road conditions, construction activity, etc., e.g., based on a comparison of the telemetry data with historical telemetry data that has been obtained and stored by data component 210 in a data store of the vehicle service. In turn, the system can determine configuration data for the vehicle based on such predicted/anticipated event(s)/conditions(s) and the subscriber profile data.

A classifier can be a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to infer an action that a user, e.g., subscriber, desires to be automatically performed. In the case of communication systems, for example, attributes can be information received from access points, services, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Further, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a memory that stores executable instructions that, when executed by the processor, facilitate performance of operations, comprising:
obtaining, via a network slice associated with a virtual network function corresponding to a vehicle service, subscriber profile data comprising preferences of a subscriber of the vehicle service;
obtaining, via the network slice, telemetry data from a group of sensors corresponding to a route;
based on the subscriber profile data and the telemetry data, determining, via the network slice, configuration data for a vehicle of the vehicle service; and
sending, via the network slice using a wireless interface, the configuration data directed to the vehicle to facilitate a selection of a configuration of the vehicle.

2. The system of claim 1, wherein the virtual network function corresponds to a group of software network functions associated with respective vehicle services comprising the vehicle service.

3. The system of claim 1, wherein the route comprises a destination of travel of the vehicle, and wherein the determining the configuration data comprises:
in response to receiving a request to travel to the destination, determining the configuration data.

4. The system of claim 3, wherein the receiving the request comprises:
in response to detecting an event that has been initiated by the subscriber, generating the request.

5. The system of claim 4, wherein the event comprises a purchase of a service corresponding to the destination.

6. The system of claim 5, wherein the service comprises a for-hire transportation service.

7. The system of claim 1, wherein the vehicle comprises an autonomous vehicle.

8. The system of claim 1, wherein the group of sensors comprises a sensor of the vehicle.

9. The system of claim 1, wherein the vehicle is a first vehicle, and wherein the group of sensors comprises a sensor of a second vehicle.

10. A method, comprising:
in response to receiving, by a system comprising a processor via a virtual network function, profile information corresponding to a subscriber of a vehicle service, and in response to receiving, by the system via the virtual network function, route information corresponding to a vehicle associated with the vehicle service, determining, by the system via the virtual network function, configuration information for the vehicle; and
sending, by the system via the virtual network function using a wireless access point device, the configuration information directed to the vehicle to facilitate a change in a configuration of the vehicle.

11. The method of claim 10, wherein the receiving the profile information comprises receiving environmental preferences for an interior of the vehicle.

12. The method of claim 10, wherein the receiving the profile information comprises receiving commute preferences representing whether the subscriber is a commuter or a tourist.

13. The method of claim 10, wherein the receiving the profile information comprises receiving original equipment manufacturing information corresponding to the vehicle.

14. The method of claim 10, wherein the receiving the route information comprises receiving telemetry data from a group of sensors corresponding to a route of the vehicle.

15. The method of claim 10, wherein the determining the configuration information comprises selecting a type of the vehicle.

16. The method of claim 10, wherein the determining the configuration information comprises determining a configuration of an interior environment of the vehicle.

17. The method of claim 10, wherein the determining the configuration information comprises determining a route of the vehicle.

18. A machine-readable storage medium, comprising executable instructions that, when executed by a processor, facilitate performance of operations, comprising:
in response to receiving request information corresponding to a designated route of a vehicle, obtaining subscriber information representing preferences of a subscriber of a vehicle service corresponding to the vehicle;
obtaining sensor data from a group of sensors corresponding to the designated route; and
in response to deriving, based on the request information, the subscriber information, and the sensor data, configuration information for the vehicle, wirelessly sending the configuration information directed to the vehicle to facilitate a performance of the vehicle service.

19. The machine-readable storage medium of claim 18, wherein the performance of the vehicle service comprises selecting the vehicle for the designated route.

20. The machine-readable storage medium of claim 18, wherein the performance of the vehicle service comprises modifying a component of the vehicle.
